(19) United States
(12) Patent Application Publication
(10) Pub. No.: US 2025/0075536 A1
(43) Pub. Date: Mar. 6, 2025

(54) CAR TAILGATE HANDLE BASE REINFORCEMENT REPAIR METHOD AND STRUCTURE

(71) Applicant: HUSHAN AUTOPARTS INC., New Taipei City (TW)

(72) Inventors: Ying-Chih Chen, New Taipei City (TW); Ching-Chiang Tsai, Taipei City (TW); Chang-Sheng Su, Keelung City (TW)

(73) Assignee: HUSHAN AUTOPARTS INC., New Taipei City (TW)

(21) Appl. No.: 18/380,685

(22) Filed: Oct. 17, 2023

(30) Foreign Application Priority Data
Aug. 28, 2023 (TW) 112132392

(51) Int. Cl. E05B 79/06

(52) U.S. Cl. CPC E05B 79/06

(57) ABSTRACT

A car tailgate handle base reinforcement and repair structure is designed to be integrated with a car tailgate handle joint. It comprises the following features: a handle base with one side being a connecting surface and the other side being an exposed surface. The connecting surface has a pivot pin on one side and an elastic pin on the opposite side. At least one reinforcement pin, placed at an appropriate location on the connecting surface, and equipped with a tab slot. A flexible tab, with one part of the tab being shaped to correspond with the tab slot's interior and the other part forming a flat spring portion. In this structure, the flexible tab is inserted into the tab slot through the connecting part, forming a connection with the reinforcement pin.

### TECHNICAL FIELD

The present invention relates to a method and a structure for reinforcing and repairing a car tailgate handle base, which are used for replacing a damaged car tailgate handle base, in particular to a car tailgate handle base structure with more reinforcing pins than the original car tailgate handle base, which has the characteristics of reduced material use, friendliness to environment and easy manufacture, and is more durable than the original car tailgate handle base or the car tailgate handle base of other manufacturers.

### BACKGROUND

Because the manufacturing technology of the old generation automobile parts has not yet reached the current level of science and technology, the plastic parts of the old generation often do not have the durability and strength of modern plastics. Especially in the old pickup truck, the weight of the car tailgate may be relatively large due to the limitation of design and manufacturing technology at that time, and the car tailgate handle base, as a key component to support and operate the car tailgate, bears considerable pressure and stress.

Therefore, these old generation plastic car tailgate handle bases may be easily broken, which may lead to the failure to open or close the door normally, and may even make the car tailgate unusable. In addition, long-term wear and external factors such as vibration, collision or extreme weather conditions may also lead to fatigue and deterioration of these plastic parts, which increases the risk of fracture. Usually, four-wheel drive pickup trucks have higher chassis settings and longer shock absorption stroke, so they have more vibration than ordinary car models.

These problems may be a problem for the owners of old pickup trucks, because it is often difficult to obtain replacement parts for these old plastic parts, and it may be very expensive to replace the whole car tailgate handle base, such as Chevy Silveradoc or GMC Sierra in 1999. When the owners often face this situation, it is difficult to obtain parts, and even if new parts are replaced, the pin of the parts may be broken due to repeated disassembly and assembly.

### SUMMARY

In order to solve the above problems, the present invention relates to a reinforcement and repair structure for a car tailgate handle base, which is used to be combined with a car tailgate handle joint, and is characterized in including: a handle base, one surface of which is a joint surface, and the other surface is an exposed surface, and one side of the joint surface is provided with a pivot pin; at least one reinforcing pin, which is arranged at an appropriate position of the joint surface, and the reinforcing pins are provided with an tab slot; a flexible tab, one part of which is an insert joint corresponding to the internal shape of the tab slot, and the other part is raised to form a flat spring portion; wherein, the flexible tab is inserted into the tab slot through the joint to be combined with the reinforcing pin.

As for a manufacturing method of the reinforcement and repair structure of the car tailgate handle base of the present invention, it is used to replace a damaged car tailgate handle base on the car tailgate handle joint, which includes: S1, a measuring step: measuring the car tailgate handle base accurately; S2, a designing step: according to the shape data of the car tailgate handle base, designing a car tailgate handle base reinforcement and repair structure, which has a handle base, one surface of which is a joint surface and the other surface is an exposed surface, and one side of the joint surface is provided with a pivot pin; at least one reinforcing pin, which is arranged at an appropriate position of the joint surface, and the reinforcing pins are provided with an tab slot; a flexible tab, one part of which is an insert joint corresponding to the internal shape of the tab slot, and the other part is raised to form a flat spring portion; wherein, the flexible tab is inserted into the tab slot through the joint to be combined with the reinforcing pin; S3, a manufacturing step: according to the data of each part of the car tailgate handle base reinforcement and repair structure designed in S2, i.e., the designing step, manufacturing the car tailgate handle base reinforcement and repair structure; S4, a repairing step: inserting the flexible tab of the car tailgate handle base reinforcement and repair structure into the tab slot through the insert joint to be combined with the reinforcement pin, then clamping the pivot pin into the car tailgate handle joint, and then pivoting the car tailgate handle base reinforcement and repair structure to make the reinforcement pin engage with the corresponding position of the car tailgate handle joint.

The main technical means of the present invention is to add a reinforcing pin, and form a flat spring portion through the protrusion to engage with the car tailgate handle joint, so that when the car body vibrates, it is not easy to be broken due to abrasion, or when it is broken due to long-term improper use by users or improper disassembly, the reinforcing pin can increase its durability, and it is not necessary to replace it with new products all the time. The flexible tab can be made of metal, which is not easy to be worn under long-term vibration. Generally, four-wheel drive pickup trucks have a higher chassis setting, and their shock absorption stroke is longer, so they have more vibration than ordinary models. Moreover, the tailgate of the old pickup truck models is relatively heavy, and its car tailgate handle base is easy to break in use.

Through the manufacturing method of the present invention, the characteristics of material use, environmental friendliness and easy manufacturing can be reduced, and the car tailgate handle base is more durable than the original car tailgate handle base or the car tailgate handle bases of other manufacturers.

### BRIEF DESCRIPTION OF DRAWINGS

FIG. 1 is a conventional diagram of the present invention;

FIG. 2 is an exploded view of the present invention;

FIG. 3 is a step diagram of the method of the present invention; and

FIG. 4 is an assembly diagram of the present invention.

### DESCRIPTION OF EMBODIMENTS

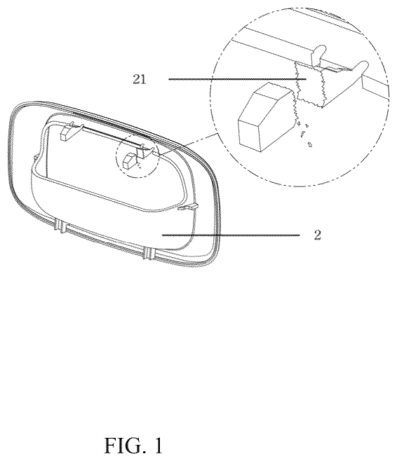

Please refer to the conventional drawing in FIG. 1. The conventional car tailgate handle base has a broken elastic pin. The conventional car tailgate handle base may be broken due to careless disassembly, wear, improper long-term use or aging of plastic, and it must be repaired or replaced with new parts. Generally, a fiber mixed dry glue can be used for bonding, but according to past experience, it will break again in about half a year, because the rubber material is not resistant to excessive wear in the current period.

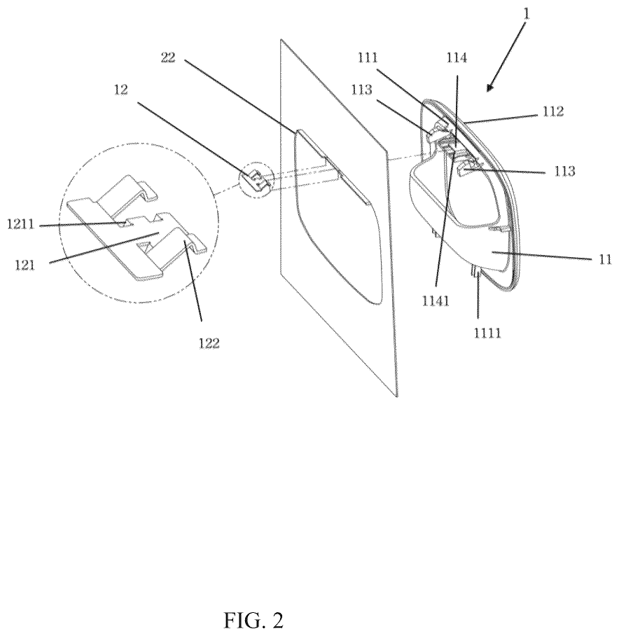

Please refer to FIG. 2, which discloses a reinforcement and repair structure for a car tailgate handle base, which is used to be combined with a car tailgate handle joint, and includes: a handle base has a joint surface on one side and an exposed surface on the other side, and one side of the joint surface is provided with a pivot pin; at least one reinforcing pin, wherein the reinforcing pin is arranged at an appropriate position of the joint surface, and the reinforcing pins have a tab slot; a flexible tab, one part of which is an insert joint corresponding to the internal shape of the tab slot, and the other part is raised to form a flat spring portion; the flexible tab is inserted into the tab slot through the insert joint to be combined with the reinforcing pin.

As shown in this figure, the reinforcement and repair structure of the car tailgate handle base can still retain the original designed elastic pin, and the joint surface has an elastic pin on the other side of the pivot pin, and the reinforcement pin can be arranged between two elastic pins. As for the flexible tab, it can be made of metal and has the characteristics of wear resistance and difficult deformation. The figure also reveals that there is at least one compression locking part at an appropriate position on the insert joint, and the compression locking part can prevent the insert joint from being separated from the tab slot.

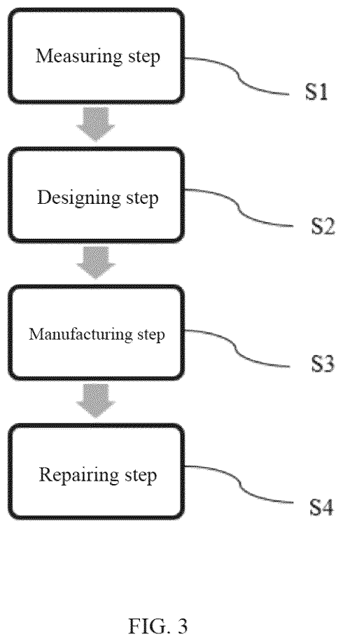

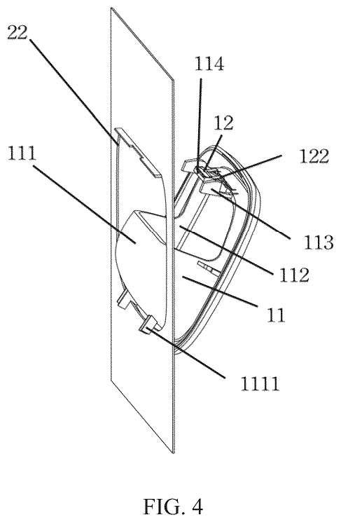

Please refer to FIG. 3 and FIG. 4 at the same time. FIG. 3 is a method step diagram of the present invention, and FIG. 4 is an assembly diagram of the present invention. These two diagrams disclose a manufacturing method of a reinforcement and repair structure for a car tailgate handle base, which is used to replace a damaged car tailgate handle base on a car tailgate handle joint (such as the conventional car tailgate handle base in FIG. 1), and includes: S1, a measuring step: measuring the car tailgate handle base accurately; S2, a designing step: according to the shape data of the car tailgate handle base, designing a car tailgate handle base reinforcement and repair structure, which has a handle base, one surface of which is a joint surface and the other surface is an exposed surface, and one side of the joint surface is provided with a pivot pin; at least one reinforcing pin, which is arranged at an appropriate position of the joint surface, and the reinforcing pins are provided with an tab slot; a flexible tab, one part of which is an insert joint corresponding to the internal shape of the tab slot, and the other part is raised to form a flat spring portion; wherein, the flexible tab is inserted into the tab slot through the insert joint to be combined with the reinforcing pin; S3, a manufacturing step: according to the data of each part of the car tailgate handle base reinforcement and repair structure designed in S2 of the designing step, manufacturing the car tailgate handle base reinforcement and repair structure; S4, a repairing step: inserting the flexible tab of the car tailgate handle base reinforcement and repair structure 1 into the tab slot through the insert joint to be combined with the reinforcement pin, then clamping the pivot pin into the car tailgate handle joint, and then pivoting the car tailgate handle base reinforcement and repair structure to make the elastic pin and the reinforcement pin engaged with the corresponding parts of the car tailgate handle joint. The fourth S4, i.e., a repairing step, may further include a gluing procedure, in which the tab slot is coated with an appropriate adhesive, and then the flexible tab is inserted into the tab slot through the insert joint to be combined with the reinforcing pin, so as to prevent the flexible tab from falling off.

The reinforcement and repair structure of the car tailgate handle base in step S2 still has an elastic pin, and the joint surface has the elastic pin on the other side of the pivot pin, and the at least one reinforcement pin can be arranged between the two elastic pins (as disclosed in FIG. 2).

What is claimed is:

1. A reinforcement and repair structure for a car tailgate handle base
used for combining with a car tailgate handle joint, comprising:
a handle base, one surface of which is a joint surface, and the other surface is an exposed surface, and one side of the joint surface is provided with a pivot pin;
at least one reinforcing pin, which is arranged at an appropriate position of the joint surface, and the reinforcing pins are provided with an tab slot;
a flexible tab, one part of which is an insert joint corresponding to the internal shape of the tab slot, and the other part is raised to form a flat spring portion;
wherein, the flexible tab is inserted into the tab slot through the joint to be combined with the reinforcing pin.

2. The reinforcement and repair structure for a car tailgate handle base according to claim 1, wherein the joint surface has an elastic pin on the other side of the pivot pin.

3. The reinforcement and repair structure for a car tailgate handle base according to claim 2, wherein the joint surface has two elastic pins, and the at least one reinforcing pin is arranged between the two elastic pins.

4. The reinforcement and repair structure for a car tailgate handle base according to claim 1, wherein the flexible tab is made of metal.

5. The reinforcement and repair structure for a car tailgate handle base according to claim 1, wherein at least one compression locking part is further arranged at an appropriate position on the insert joint, and the compression locking part can prevent the insert joint from being separated from the tab slot.

6. A manufacturing method for a reinforcement and repair structure for a car tailgate handle base used for replace a damaged car tailgate handle base on a car tailgate handle joint, comprising:
S1, a measuring step: measuring the car tailgate handle base accurately;
S2, a designing step: according to the shape data of the car tailgate handle base, designing a car tailgate handle base reinforcement and repair structure, which has a handle base, one surface of which is a joint surface and the other surface is an exposed surface, and one side of the joint surface is provided with a pivot pin; at least one reinforcing pin, which is arranged at an appropriate position of the joint surface, and the reinforcing pins are provided with an tab slot; a flexible tab, one part of which is an insert joint corresponding to the internal shape of the tab slot, and the other part is raised to form a flat spring portion; wherein, the flexible tab is inserted into the tab slot through the joint to be combined with the reinforcing pin;
S3, a manufacturing step: according to the data of each part of the car tailgate handle base reinforcement and repair structure designed in S2, i.e., the designing step, manufacturing the car tailgate handle base reinforcement and repair structure;
S4, a repairing step: inserting the flexible tab of the car tailgate handle base reinforcement and repair structure into the tab slot through the insert joint to be combined with the reinforcement pin, then clamping the pivot pin into the car tailgate handle joint, and then pivoting the car tailgate handle base reinforcement and repair structure to make the reinforcement pin engage with the corresponding position of the car tailgate handle joint.

7. The method according to claim 6, wherein the S4, i.e., the repairing step, further comprises a gluing procedure, in which the tab slot is coated with an appropriate adhesive, and then the flexible tab is inserted into the tab slot through the insert joint to be combined with the reinforcing pin.

8. The method according to claim 6, wherein in the S2, i.e., the designing step, the joint surface has an elastic pin on the other side of the pivot pin.

9. The method according to claim 8, wherein in the S2, wherein the joint surface has two elastic pins, and the at least one reinforcing pin is arranged between the two elastic pins.
